(19) United States
(12) Patent Application Publication
(10) Pub. No.: US 2024/0141112 A1
(43) Pub. Date: May 2, 2024

(54) CURABLE POLYOLEFIN COMPOSITION AND CURED PRODUCT

(71) Applicants: Chao He, Shanghai (CN); Peng WEI, Shanghai (CN); Jiguang ZHANG, Shanghai (CN); Hongyu CHEN, Shanghai (CN); Yan ZHENG, Shanghai (CN); Chen CHEN, Shanghai (CN); Dorab BHAGWAGAR, Auburn, MI (US); DOW SILICONES CORPORATION, Midland, MI (US); DOW GLOBAL TECHNOLOGIES LLC, Midland, MI (US)

(72) Inventors: Chao HE, Shanghai (CN); Peng WEI, Shanghai (CN); Jiguang ZHANG, Shanghai (CN); Hongyu CHEN, Shanghai (CN); Yan ZHENG, Shanghai (CN); Chen CHEN, Shanghai (CN); Dorab BHAGWAGAR, Auburn, MI (US)

(21) Appl. No.: 18/278,649

(22) PCT Filed: Mar. 3, 2021
(86) PCT No.: PCT/CN2021/078818

§ 371 Date: Aug. 24, 2023

(51) Int. Cl. C08G 77/442; C08K 3/22; C08L 91/06; C09K 5/06

(52) U.S. Cl. CPC C08G 77/442; C08K 3/22; C08L 91/06; C09K 5/063; C08K 2003/2227; C08K 2201/003

(57) ABSTRACT

Curable polyolefin composition comprising: (A) polyolefin having at least two aliphatic unsaturated bonds per molecule; (B) wax with melting point of 30 to 100° C.; (C) organopolysiloxane having at least two silicon atom-bonded hydrogen atoms per molecule; and (D) catalytic amount of hydrosilylation reaction catalyst, wherein content of component (A) is 20 to 80 mass %, content of component (B) is 10 to 75 mass %, and content of component (C) is 1 to 20 mass %, each based on the total mass of components (A) to (D). The composition can be cured to form a cured product capable of storing and releasing thermal energy, and preventing the wax leaking/pumping out during heat cycling.

### TECHNICAL FIELD

The present invention relates to a curable polyolefin composition and a cured product thereof.

### BACKGROUND ART

Phase change materials (PCM) are known as latent heat storage materials that utilize phase change of the materials themselves to passively absorb or release a large amount of heat from surrounding environment, thereby are used in recent years for cooling electronic devices such as mobile phones, smartphones and tablets, in which power inherently fluctuates with time. The power fluctuation may occur during short time intervals, such as minutes, or during longer time intervals, such as days. When temperature peaks, the PMC melts storing the excess thermal energy. When the temperature falls, the PMC solidifies, releasing the stored thermal energy.

For example, Patent Document 1 discloses gel-coated microcapsules containing PCM, wherein the microcapsules are produced by Sol-Gel process to encapsulate the PCM particles. However, there are problem that its cost is high, and the process has low repeatability and loading content of the PCM is low. When loading content of the PMC is low, capability of storing thermal energy and of releasing it, namely, enthalpy of phase change (J/g) becomes lower than 20 J/g.

Patent Document 2 discloses a silicone elastomer composition comprising: at least one room-temperature vulcanizing “RTV” silicone elastomer and at least one PCM. And, Patent Document 3 discloses a hot melt sealant/adhesive composition comprising: a siloxane polymer, a hot melt resin, and/or an organic resin. However, there are problems that it is too hard to disperse PCM in the silicone elastomer or the siloxane polymer due to compatibility issue between the PCM and the silicone. As a result, the PMC will leakage/pump out from cured product during heat cycling.

### PRIOR ART DOCUMENTS

### Patent Documents

Patent Document 1: U.S. Pat. No. 6,270,836 B1
Patent Document 2: U.S. Patent Application Publication No. 2014/0030458 A1
Patent Document 3: U.S. Pat. No. 8,088,869 B2

### SUMMARY OF INVENTION

### Technical Problem

An object of the present invention is to provide a curable polyolefin composition can be cured to form a cured product capable of storing thermal energy and of releasing it, wherein the cured product can prevent the wax leaking/pumping out during heat cycling.

### Solution to Problem

The curable polyolefin composition of the present invention comprises:
(A) a polyolefin having at least two aliphatic unsaturated bonds per molecule;
(B) a wax with a melting point of 30 to 100° C.;
(C) an organopolysiloxane having at least two silicon atom-bonded hydrogen atoms per molecule; and
(D) a catalytic amount of a hydrosilylation reaction catalyst,
wherein a content of component (A) is 20 to 80 mass %, a content of component (B) is 10 to 75 mass %, and a content of component (C) is 1 to 20 mass %, each based on a total mass of components (A) to (D).

In various embodiments, component (A) is a polybutadiene.

In various embodiments, component (B) is a wax selected from a paraffin wax, a microcrystalline wax, or a polyethylene wax.

In various embodiments, the thermal interface material further comprises: (E) at least one inorganic filler.

In various embodiments, component (E) is at least one inorganic filler selected from a flame retardant filler or a thermal conductive filler.

In various embodiments, a content of component (E) is not more than 50 mass % of the present composition.

The cured product of the present invention is obtained by curing the curable polyolefin composition described above.

### Effects of Invention

The curable polyolefin composition of the present invention can be cured to form a cured product capable of storing thermal energy and of releasing it, wherein the cured product can prevent the wax leaking/pumping out during heat cycling. In especial, the cured product has good phase change properties with enthalpy of from 20 to 140 J/g, whereas the cured product is fully cured with no leakage of the wax during heat cycling.

### BRIEF DESCRIPTION OF THE DRAWINGS

FIG. 1 is a Differential Scanning calorimetry (DSC) chart for instance to measure a temperature of phase change and enthalpy of phase change in Examples.

### DEFINITIONS

The terms “comprising” or “comprise” are used herein in their broadest sense to mean and encompass the notions of “including,” “include,” “consist(ing) essentially of,” and “consist(ing) of.” The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

The term “wax” is used herein to mean a material which is solid at ambient temperature (e.g., at 25° C.) and exhibits softening or melting characteristics at elevated temperatures.

### DETAILED DESCRIPTION OF THE INVENTION

The curable polyolefin composition of the present invention will be explained in detail.

Component (A) is a main component and a polyolefin having at least two aliphatic unsaturated bonds per molecule. Here, component (A) is a polyolefin grafted on the main chain groups with aliphatic unsaturated bonds, or a polyolefin having a main chain including aliphatic carbon-carbon unsaturated bonds. Component (A) may be linear or branched and may be a homopolymer, copolymer or terpolymer. Component (A) may also be present as a mixture of different polyolefins so long as there is on average at least two aliphatic unsaturated bonds per molecule. Examples of the polyolefin for component (A) include a polyisoprene, a polybutadiene, a copolymer of isobutylene and isoprene, a copolymer of isoprene and butadiene, a copolymer of isoprene and styrene, a copolymer of butadiene and styrene, a copolymer of isoprene, butadiene and styrene and a polyolefin polymer prepared by hydrogenating polyisoprene, polybutadiene or a copolymer of isoprene and styrene, a copolymer of butadiene and styrene or a copolymer of isoprene, butadiene and styrene. Among them, component (A) is preferably a polybutadiene.

The aliphatic unsaturated bonds in a molecule of component (A) may be the same or different and may comprises 2 or more carbon atoms, but preferably comprise between 2 and 12 carbon atoms. They may be linear or branched but linear alkenyl groups are preferred. Examples of suitable groups with aliphatic unsaturated bond include alkenyl groups such as vinyl groups, allyl groups, butenyl groups, pentenyl groups, and hexenyl groups, and vinyl and/or allyl groups are particularly preferred. The groups with aliphatic unsaturated bond may be found pendant along the polymer chain or at the chain ends, with it being preferable for the groups to be at the chain ends.

The state of component (A) at 25° C. is not limited, but it is preferably a liquid. Component (A) preferably has a viscosity at 25° C. of 1 to 100 Pa·s. Note that in the present specification, viscosity may be measured in accordance with JIS K7117-1: Plastics—Resins in the liquid state or as emulsions or dispersions—Determination of apparent viscosity by the Brookfield Test method, or ISO 2555: Plastics Resins in the Liquid State or as Emulsions or Dispersions Determination of Apparent Viscosity by the Brookfield Teste Method.

The molecular weight of component (A) is not limited, but it is preferably a number average molecular weight (GPC method, in terms of polystyrene) of 100,000 or less, more preferably about 500 to 100,000. In particular, liquids having a fluidity of about 1,000 to 40,000 and fluidity are preferred from the viewpoint of ease of handling.

An exemplary commercially available polyolefin is liquid polybutadienes Ricon® 130, 131, 131 MA10, 134, 138, and 181; Poly bd® R-45-V, available from CRAY VALLEY.

The content of component (A) is in a range of from 20 to 80 mass %, alternatively in a range of from 25 to 80 mass %, each based on a total mass of components (A) to (D). This is because when the content of component (A) is equal to or greater than the lower limit of the range described above, curability of the present composition is good, whereas when the content of component (A) is equal to or less than the upper limit of the range described above and the content of component (B) is higher, phase change properties of the cured product are good.

Component (B) is a wax compatible with component (A) and acts as a phase change material that undergoes a reversible solid-liquid phase change at or below the maximum operating temperatures of electronic devices. Component (B) has a melting point of 30 to 100° C., preferably 35 to 100° C., 35 to 80° C., alternatively 35 to 70° C. When cooled below its melting point, component (B) solidifies, thereby maintaining intimate contact between heat generating electronic components and heat spreader. Note that in the present specification, melting point (° C.) may be measured by a Differential Scanning calorimeter (DSC) in accordance with ASTM D3418. Compatibility between components (A) and (B) can be judged by ASTM D6038: Standard Test Methods for Determining the Compatibility of Resin/Solvent Mixtures by Precipitation Temperature (Cloud Point)

Exemplary waxes for component (B) include paraffin waxes, microcrystalline waxes, and polyethylene waxes. Preferred waxes are C₁₂-C₂₅ paraffin waxes.

The content of component (B) is in a range of from 10 to 75 mass %, alternatively in a range of from 20 to 75 mass %, or alternatively in a range of from 30 to 75 mass %, or alternatively in a range of from 40 to 75 mass %, each based on a total mass of components (A) to (D). This is because when the content of component (B) is equal to or greater than the lower limit of the range described above, phase change properties of the cured product are good, whereas when the content of component (B) is equal to or less than the upper limit of the range described above, curability of the present composition is good.

Component (C) is an organopolysiloxane having at least two silicon atom-bonded hydrogen atoms per molecule. Organic groups in the organopolysiloxanes for component (C) are exemplified by monovalent hydrocarbon groups free of aliphatic unsaturated bonds, such as methyl groups, ethyl groups, propyl groups, butyl groups, pentyl groups, hexyl groups, heptyl groups, and other alkyl groups having 1 to 12 carbon atoms; phenyl groups, tolyl groups, xylyl groups, naphthyl group, and other aryl groups having 6 to 12 carbon atoms, and methyl groups and phenyl groups are most typical.

The organopolysiloxanes for component (C) are exemplified by methylphenylpolysiloxane having both terminals of the molecular chain end-blocked by dimethylhydrogensiloxy groups; methylphenylsiloxane-dimethylsiloxane copolymer having both terminals of the molecular chain end-blocked by dimethylhydrogensiloxy groups; methylphenylsiloxane-methylhydrogensiloxane copolymer having both terminals of the molecular chain end-blocked by trimethylsiloxy groups; methylphenylsiloxane-methylhydrogensiloxane-dimethylsiloxane copolymer having both terminals of the molecular chain end-blocked by trimethylsiloxy groups; organopolysiloxane copolymer made up of siloxane units represented by (CH₃)₂HSiO_{1/2} and siloxane units represented by C₆H₅SiO_{3/2}; organopolysiloxane copolymer made up of siloxane units represented by (CH₃)₂HSiO_{1/2}, siloxane units represented by (CH₃)₃SiO_{1/2}, and siloxane units represented by C₆H₅SiO_{3/2}; organopolysiloxane copolymer made up of siloxane units represented by (CH₃)₂HSiO_{1/2}, siloxane units represented by (CH₃)₂SiO_{2/2}, and siloxane units represented by C₆H₅SiO_{3/2}; organopolysiloxane copolymer made up of siloxane units represented by (CH₃)₂HSiO_{1/2}, siloxane units represented by C₆H₅(CH₃)₂SiO_{1/2}, and siloxane units represented by SiO_{4/2}; organopolysiloxane copolymer made up of siloxane units represented by (CH₃)HSiO_{2/2} and siloxane units represented by C₆H₅SiO_{3/2}; as well as mixtures of two or more of the above.

The content of component (C) is in a range of from 1 to 20 mass %, alternatively in a range of from 1 to 15 mass %, alternatively in a range of from 1 to 10 mass %, or alternatively in a range of from 2 to 10 mass %, each based on a total mass of components (A) to (D). This is because the composition can be satisfactorily cured if the content of component (C) is not less than the lower limit of the above-mentioned range and the heat resistance of the cured product is improved if the content of component (C) is not more than the upper limit of the above-mentioned range.

Component (D) is a hydrosilylation reaction catalyst used to facilitate curing of the present composition, and examples of component (D) include platinum-based catalysts, rhodium-based catalysts, and palladium-based catalysts. Component (D) is typically a platinum-based catalyst so that the curing of the present composition can be dramatically accelerated. Examples of the platinum-based catalyst include a platinum fine powder, chloroplatinic acid, an alcohol solution of chloroplatinic acid, a platinum-alkenylsiloxane complex, a platinum-olefin complex and a platinum-carbonyl complex, with a platinum-alkenylsiloxane complex being most typical.

The content of component (D) in the present composition is an effective quantity for facilitating curing of the present composition. Specifically, in order to satisfactorily cure the present composition, the content of component (D) is typically a quantity whereby the content of catalytic metal in component (D) relative to the present composition is from 0.01 to 500 ppm, alternatively from 0.01 to 100 ppm, alternatively from 0.01 to 50 ppm, in terms of mass units.

The present material may further comprise (E) at least one inorganic filler. Exemplary fillers for component (E) include a flame retardant filler and a thermal conductive filler. Component (E) can be any one or any combination of more than one thermally conductive filler selected from metals, alloys, nonmetals, metal oxides, metal hydroxides, or ceramics. Exemplary metals include but are not limited to aluminum, copper, silver, zinc, nickel, tin, indium, and lead. Exemplary nonmetals include but are not limited to carbon, graphite, carbon nanotubes, carbon fibers, graphenes, and silicon nitride. Exemplary metal oxides, metal hydroxides and ceramics include but are not limited to alumina, aluminum nitride, aluminum hydroxide, boron nitride, zinc oxide, and tin oxide. Desirably, component (E) is any one or any combination of more than one selected from a group consisting of alumina, aluminum, zinc oxide, boron nitride, aluminum nitride, and aluminum hydroxide. Even more desirably, component (E) is any one or any combination or more than one filler selected from aluminum hydroxide having an average size of 1 to 15 μm, spherical aluminum particles having an average size of 5 to 15 μm, spherical aluminum particles having an average particle size of 1 to 3 μm, zinc oxide particles having an average particle size of 0.1 to 0.5 μm. Determine average particle size for filler particles as the median particle size (D50) using laser diffraction particle size analyzers (CILAS920 Particle Size Analyzer or Beckman Coulter LS 13 320 SW) according to an operation software.

The amount of component (E) is not limited, but it is preferably not more than 50 mass % of the present composition. This is because when the content of component (E) is equal to or less than the upper limit of the range described above, phase change properties of the cured product are good.

The present composition may further comprise additional components such as one or more additives. Such additives include, but are not limited to, antioxidants, antistatic agents, color enhancers, dyes, lubricants, fillers such as TiO₂ or CaCO₃, opacifiers, nucleators, pigments, processing aids, UV stabilizers, anti-blocks, slip agents, tackifiers, fire retardants, anti-microbial agents, odor reducer agents, anti-fungal agents, and combinations thereof.

The present composition can be prepared by combining all of ingredients at ambient temperature. Any of the mixing techniques and devices described in the prior art can be used for this purpose. The particular device used will be determined by the viscosity of the ingredients and the final composition. Cooling of the ingredients during mixing may be desirable to avoid premature curing.

The cured product of the present invention is obtained by curing the curable polyolefin composition described above. The present cured product can be used as a thermal interface material or an encapsulant for electric devices.

### Examples

The curable polyolefin composition and the cured product of the present invention will be described in detail hereinafter using Practical Examples and Comparative Examples. However, the present invention is not limited by the description of the below listed Practical Examples.

### <Curing Time>

Curing time was measured by a durometer test method. After curing starting, the time required for the hardness change to stabilize (vary less than 5 Shore A) was set as curing time. The hardness test used Shore A according to ASTM D 2240.

### <Temperature of Phase Change and Enthalpy of Phase Change>

Temperature of phase change and enthalpy of phase change were tested by DSC on DSC-Q2000 instrument in accordance with ASTM D3418. The method is executed under the following conditions:
1: Equilibrate at 0.0° C.
2: Data storage: On
3: Ramp 10.0° C./min to 150.0° C.
4: Isothermal for 5.00 mins.
5: Mark end of cycle 1
6: Ramp 10.0° C./min to 0.0° C.
7: Isothermal for 5.00 mins.
8: Mark end of cycle 2
9: Ramp 10.0° C./min to 150.0° C.
10: Mark end of cycle 3
11: End of method

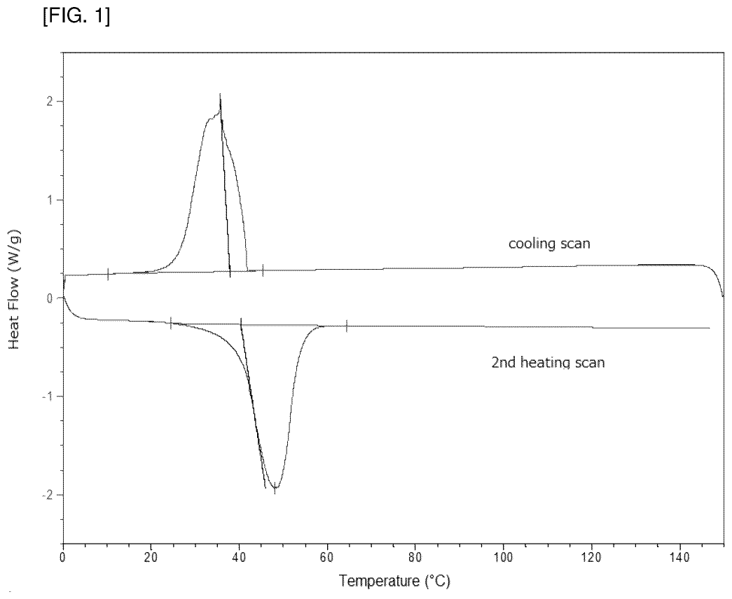

The data was collected at the cycle 2 heating scan step as FIG. 1.

<Wax Leakage after Heat Cycling>

Wax leakage was evaluated by the following procedures:
(1) Place 20 g of the curable polyolefin composition in a 40 mL closed clear glass jar.
(2) Heat to cure the composition
(3) then do the heat cycling from 25° C. to 80° C. for at least 10 times
(4) Tare a disposable aluminum pan, place the inverted open glass jar on the aluminum pan for 10 mins at 100° C., then remove the glass jar and weigh the aluminum pan.
(5) Calculate mass % of leakage component to total composition mass. When the mass % of leakage component >3 mass %, it will be identified as Wax leakage “Observed,” otherwise, “None.”

### Practical Examples 1-14 and Comparative Examples 1-3

Curable polyolefin compositions shown in Table 1 were prepared using the components mentioned below. Components (A) and (B) were mixed at 60° C. homogeneously. And then, components (C), (D), and optionally component (D) were added and mixed under speed mixture with a rate of 1000 rpm for 20 seconds.

The following components were used as component (A).
Component (a-1): a liquid polybutadiene (trade name: Ricon® 131, commercially available from TOTAL CRAY VALLEY; Mn=4,500)
Component (a-2): a liquid hydroxyl terminated polybutadiene (trade name: Poly bd® R45 V, commercially available from TOTAL CRAY VALLEY; Mn=2,800)
Component (a-3): a liquid polybutadiene (trade name: Ricon® 131MA10, commercially available from TOTAL CRAY VALLEY; Mn=5,000)
Component (a-4): a liquid polybutadiene (trade name: Ricon® 181, commercially available from TOTAL CRAY VALLEY; Mn=3,200)

The following components were used as component (B).
Component (b-1): a paraffin wax (commercially available from SCRC; Melting point=52-54° C.)
Component (b-2): docosane (commercially available from SCRC; Melting point=43-47° C.)

The following components were used as component (C).
Component (c-1): a trimethylsiloxy-terminated dimethylsiloxane methylhydrogen siloxane copolymer (SiH content=0.78 mass %)
Component (c-2): tetrakis(dimethylsilyl) silane (SiH content=1.23 mass %)

The following component was used as component (D).
Component (d-1): a 1,3-divinyl-1,1,3,3-tetramethyl disiloxane solution of a Pt complex with 1,3-divinyl-1,1,3,3-tetramethyldisiloxane (Pt content=5,000 ppm)

The following components were used as component (E).
Component (e-1): aluminum hydroxide filler having an average particle diameter of 15-25 μm (trade name: MARTINAL® ON-320, commercially available from HUBER MARTINSWERK)
Component (e-2): spherical aluminum nitride filler having an average particle diameter of 30 μm (trade name: ANF-30, commercially available from MARUWA)
Component (e-3): roundish shaped aluminum oxide filler having an average particle diameter of 35 μm (trade name: A-ST-60, commercially available from ZRI)

TABLE 1

| | | | Category | | | | | | |
|---|---|---|---|---|---|---|---|---|---|
| | | | Practical Examples | | | | | | |
| Item | | | IE1 | IE2 | IE3 | IE4 | IE5 | IE6 | IE7 |
| Curable | (A) | (a-1) | 16.8 | 51.8 | 25.3 | 20.0 | 20.2 | 51.6 | 39.6 |
| Polyolefin | | (a-2) | 0 | 0 | 0 | 0 | 0 | 0 | 0 |
| Composition | | (a-3) | 0 | 0 | 0 | 0 | 0 | 0 | 0 |
| (parts | | (a-4) | 0 | 0 | 0 | 0 | 0 | 0 | 0 |
| by | (B) | (b-1) | 33.6 | 0 | 30.4 | 45.0 | 64.7 | 0 | 0 |
| mass) | | (b-2) | 0 | 10.0 | 0 | 0 | 0 | 41.3 | 45.0 |
| | (C) | (c-1) | 2.1 | 6.5 | 3.2 | 2.5 | 2.5 | 6.5 | 0 |
| | | (c-2) | 0 | 0 | 0 | 0 | 0 | 0 | 3.2 |
| | (D) | (d-1) | 0.5 | 0.6 | 0.5 | 0.5 | 0.5 | 0.6 | 0.4 |
| | (E) | (e-1) | 47.0 | 31.1 | 40.6 | 32.0 | 12.1 | 0 | 11.8 |
| | | (e-2) | 0 | 0 | 0 | 0 | 0 | 0 | 0 |
| | | (e-3) | 0 | 0 | 0 | 0 | 0 | 0 | 0 |

| | | | | | | | |
|---|---|---|---|---|---|---|---|
| Curing time (mins.) | 30 | 45 | 45 | 45 | 120 | 60 | 75 |
| Temperature of | 36-54 | 42 | 39-56 | 38-55 | 38-55 | 46 | 46 |
| phase change (° C.) | | | | | | | |
| Enthalpy of Phase | 75 | 21 | 63 | 103 | 139 | 95 | 120 |
| Change (J/g) | | | | | | | |
| Wax leakage after | None | None | None | None | None | None | None |
| heat cycling | | | | | | | |

| | | | Category | | | | | |
|---|---|---|---|---|---|---|---|---|
| | | | Practical Examples | | | | | |
| Item | | | IE8 | IE9 | IE10 | IE11 | IE12 | IE13 |
| Curable | (A) | (a-1) | 20.3 | 0 | 0 | 0 | 20.2 | 0 |
| Polyolefin | | (a-2) | 0 | 21.5 | 0 | 0 | 0 | 46.8 |
| Composition | | (a-3) | 0 | 0 | 36.5 | 0 | 0 | 0 |
| (parts | | (a-4) | 0 | 0 | 0 | 36.5 | 0 | 0 |
| by | (B) | (b-1) | 0 | 0 | 0 | 0 | 45.5 | 0 |
| mass) | | (b-2) | 45.0 | 43.0 | 36.5 | 36.5 | 0 | 37.4 |
| | (C) | (c-1) | 0 | 2.7 | 4.6 | 4.6 | 1.5 | 5.9 |
| | | (c-2) | 1.6 | 0 | 0 | 0 | 0 | 0 |
| | (D) | (d-1) | 0.5 | 0.5 | 0.5 | 0.5 | 0.5 | 0.5 |
| | (E) | (e-1) | 32.6 | 32.3 | 21.9 | 21.9 | 32.3 | 0 |
| | | (e-2) | 0 | 0 | 0 | 0 | 0 | 9.4 |
| | | (e-3) | 0 | 0 | 0 | 0 | 0 | 0 |

| | | | | | | |
|---|---|---|---|---|---|---|
| Curing time (mins.) | 30 | 45 | 120 | 60 | 120 | 60 |
| Temperature of | 46 | 50 | 44 | 44 | 34-53 | 43 |
| phase change (° C.) | | | | | | |
| Enthalpy of Phase | 136 | 121 | 136 | 105 | 129 | 89 |
| Change (J/g) | | | | | | |
| Wax leakage after | None | None | None | None | None | None |
| heat cycling | | | | | | |

| | | | Category | | | |
|---|---|---|---|---|---|---|
| | | | Prac. Exam. | Comparative Examples | | |
| Item | | | IE14 | CE1 | CE2 | CE3 |
| Curable | (A) | (a-1) | 0 | 30.0 | 61.9 | 18.0 |
| Polyolefin | | (a-2) | 46.8 | 0 | 0 | 0 |
| Composition | | (a-3) | 0 | 0 | 0 | 0 |
| (parts | | (a-4) | 0 | 0 | 0 | 0 |
| by | (B) | (b-1) | 0 | 70.0 | 0 | 0 |
| mass) | | (b-2) | 37.4 | 0 | 5.0 | 70.2 |
| | (C) | (c-1) | 5.9 | 0 | 7.7 | 2.3 |
| | | (c-2) | 0 | 0 | 0 | 0 |
| | (D) | (d-1) | 0.5 | 0 | 0.6 | 0.5 |
| | (E) | (e-1) | 0 | 0 | 24.8 | 9.0 |
| | | (e-2) | 0 | 0 | 0 | 0 |
| | | (e-3) | 9.4 | 0 | 0 | 0 |

| | | | | |
|---|---|---|---|---|
| Curing time (mins.) | 60 | Not cured | 60 | Not cured |
| Temperature of | 43 | 37-55 | 36 | — |
| phase change (° C.) | | | | |
| Enthalpy of Phase | 92 | 123 | 7.0 | — |
| Change (J/g) | | | | |
| Wax leakage after | None | Observed | None | Observed |
| heat cycling | | | | |

The curing performance is key for an encapsulant. As shown in Table 1, the comparative compositions of CE1 and CE3 were not cured because of none of component (C) as a cross-linking agent and over loading of component (B). When loading content of component (A) is higher than 20 mass % of a total amount of components (A) to (D), curing performances were good (IE1 to IE9), and each curing times of all the present compositions is less than 3 hrs. at 60° C. regardless of different component (A) (IE9, IE10 and IE11) and different component (C) (IE7 and IE8) and different component (E) (IE13 and IE14). The enthalpy of phase change (J/g) is another key property for the encapsulant. Each enthalpy of phase change for the present compositions was in a range of from 20 to 140 J/g, which was depended on the type and loading content of wax (IE1 to IE14). However, the enthalpy of phase change (J/g) was such low that could not be used as a PCM heat absorbing material when loading content of wax was less than 10 mass % of a total amount of components (A) to (D) (CE2). Inorganic fillers can also be used in the present composition, which had no impact of the curing and phase change properties, and its loading content can be as high as 47 mass % of the present composition (IE1). Moreover, the cured products of the present compositions had no wax leakage after heat cycling between 25 to 80° C.

### INDUSTRIAL APPLICABILITY

The curable polyolefin composition of the present invention can be cured to form a phase change material which will prevent leakage/pump out during heat cycling. Therefore, the curable polyolefin composition is useful for an encapsulant or sealant for electronic devices such as mobile phones.

1. A curable polyolefin composition comprising:
(A) a polyolefin having at least two aliphatic unsaturated bonds per molecule;
(B) a wax with a melting point of 30 to 100° C.;
(C) an organopolysiloxane having at least two silicon atom-bonded hydrogen atoms per molecule; and
(D) a catalytic amount of a hydrosilylation reaction catalyst,
wherein a content of component (A) is 20 to 80 mass %, a content of component (B) is 10 to 75 mass %, and a content of component (C) is 1 to 20 mass %, each based on a total mass of components (A) to (D).

2. The curable polyolefin composition according to claim 1, wherein component (A) is a polybutadiene.

3. The curable polyolefin composition according to claim 1, wherein component (B) is a wax selected from a paraffin wax, a microcrystalline wax, or a polyethylene wax.

4. The curable polyolefin composition according to claim 1, further comprising: (E) at least one inorganic filler.

5. The curable polyolefin composition according to claim 4, wherein component (E) is at least one inorganic filler selected from a flame retardant filler or a thermal conductive filler.

6. The curable polyolefin composition according to claim 4, wherein a content of component (E) is not more than 50 mass % of the composition.

7. A cured product obtained by curing the curable polyolefin composition according to claim 1.
